(19) United States
(12) Patent Application Publication
(10) Pub. No.: US 2017/0368697 A1
(43) Pub. Date: Dec. 28, 2017

(54) Wrist Structure of Industrial Robot

(71) Applicant: FANUC CORPORATION, Minamitsuru-gun (JP)

(72) Inventor: Toshihiko Inoue, Minamitsuru-gun (JP)

(73) Assignee: FANUC CORPORATION, Minamitsuru-gun (JP)

(21) Appl. No.: 15/630,241

(22) Filed: Jun. 22, 2017

(30) Foreign Application Priority Data
Jun. 27, 2016 (JP) 2016-126508

(51) Int. Cl. B25J 17/02; B25J 9/10; B25J 19/00

(52) U.S. Cl. CPC B25J 17/0283; B25J 19/0029; B25J 9/102; Y10S 901/29; Y10S 901/25

(57) ABSTRACT

A first hollow part having a center axis coincident with a first axis of a wrist structure is formed in a forearm. A through passage, which communicates with the first hollow part is formed in a first wrist element. A second hollow part having a center axis coincident with a third axis is formed in a third wrist element. An umbilical member is inserted through the first hollow part, the through passage, and the second hollow part. A brake device is eliminated from at least one of a motor for a second wrist and a motor for a third wrist.

### BACKGROUND OF THE INVENTION

### 1. Field of the Invention

The present invention relates to a wrist structure of an industrial robot provided with wrist elements having three degrees of rotational freedom.

### 2. Description of the Related art

Conventionally, in industrial robots, a wrist structure having a first wrist element, a second wrist element rotatably supported by a distal end of the first wrist element, and a third wrist element rotatably supported by a distal end of the second wrist element, wherein the power of a motor for a second wrist and a motor for a third wrist, which are provided in the first wrist element, is transmitted to the second wrist element and the third wrist element via hypoid gear sets each having a pinion gear and a ring gear, has been known (see, for example, Japanese Patent No. 4233578 and Japanese Unexamined Patent Publication (Kokai) No. 2014-213437).

### SUMMARY OF THE INVENTION

In a wrist structure, an operation tool is often situated at an offset position relative to a wrist flange. Further, even when the operation tool is disposed on a rotation axis of the wrist flange, an umbilical member for controlling the operation tool may be disposed outside an arm as described in Japanese Patent No. 4233578 and Japanese Unexamined Patent Publication (Kokai) No. 2014-213437.

In such a case, a gravitational load caused by, for example, the umbilical member for controlling the operation tool, acts on each output axis of wrist axes. Thus, at the time of shutdown or emergency shutdown, members associated with wrist axes tend to be accidentally detached. Further, when all of first to third axes of the wrist are situated at offset positions, depending on the orientation of the second and third axes, a gravitational load of the operation tool, which acts on the first axis, increases, and accordingly, the possibility that members associated with the axes may be accidentally detached increases.

In order to prevent the members associated with the axes from being accidentally detached, it is preferable that a brake is attached to each of the wrist axes (first to third axes) of the wrist structure. However, attaching the brake to each wrist axis increases the entire weight of the wrist structure, and accordingly, makes it difficult for the wrist structure to quickly move and to be precisely positioned.

The present invention was made in light of the circumstances described above and has an object to provide a wrist structure of an industrial robot, which can quickly move and can be precisely positioned without accidental detachment of members associated with axes.

A first aspect of the invention provides a wrist structure of an industrial robot. The wrist structure includes a forearm, a first wrist element which is hinge-connected to a distal end of the forearm and which is rotatable about a first axis, a second wrist element which is provided in the first wrist element so as to be rotatable about a second axis perpendicular to the first axis, a third wrist element which is provided in the second wrist element so as to be rotatable about a third axis perpendicular to the second axis, and an umbilical member which connects an operation tool attached to a tool attachment part of the third wrist element to a tool management relay device disposed behind the forearm, to supply at least one of power, a signal, and a material to the operation tool. The wrist structure of the industrial robot also includes a first reduction gear for rotationally driving the first wrist element, a first deceleration unit and a second deceleration unit for rotationally driving the second wrist element; a third deceleration unit for rotationally driving the third wrist element; a motor for a second wrist and a motor for a third wrist, which respectively drive the second wrist element and the third wrist element, and a transmission mechanism for the second wrist and a transmission mechanism for the third wrist, which respectively transmit a rotationally driving force of the motor for the second wrist and a rotationally driving force of the motor for the third wrist to the second wrist element and the third wrist element and which include hypoid gear sets. A first hollow part having a center axis coincident with the first axis is formed in the forearm. A through passage, which communicates with the first hollow part, is formed in the first wrist element. A second hollow part having a center axis coincident with the third axis is formed in the third wrist element. The umbilical member is inserted through the first hollow part, the through passage, and the second hollow part. A brake device is eliminated from at least one of the motor for the second wrist and the motor for the third wrist.

These objects, features, and advantages of the present invention and other objects, features, and advantages will become further clearer from the detailed description of typical embodiments illustrated in the appended drawings.

### BRIEF DESCRIPTION OF THE DRAWINGS

FIG. 1 is a front view illustrating the internal configuration of a wrist structure of an industrial robot according to an embodiment of the present invention.

FIG. 2 is a side view illustrating the internal configuration of a wrist structure of the industrial robot according to an embodiment of the present invention.

FIG. 3 is a side view illustrating an example of an industrial robot to which a wrist structure according to an embodiment of the present invention is applied.

FIG. 4 is a side view illustrating an example of an industrial robot to which a wrist structure according to an embodiment of the present invention is applied.

FIG. 5 is a perspective view, seen from obliquely behind, of a first wrist element constituting a wrist structure according to an embodiment of the present invention.

### DETAILED DESCRIPTION

Embodiments of the present invention will be described below with reference to the accompanying drawings. In the following figures, similar members are designated with the same reference numerals. These figures are properly modified in scale to assist the understanding thereof.

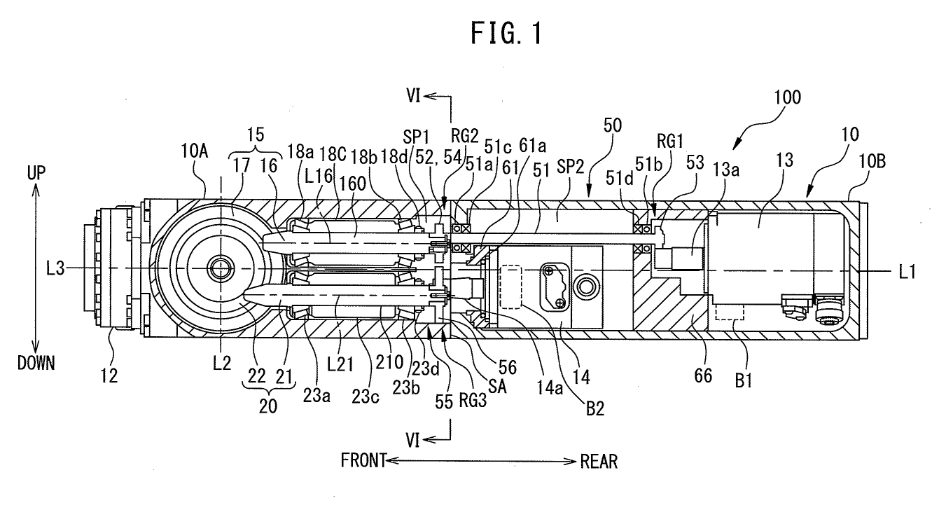

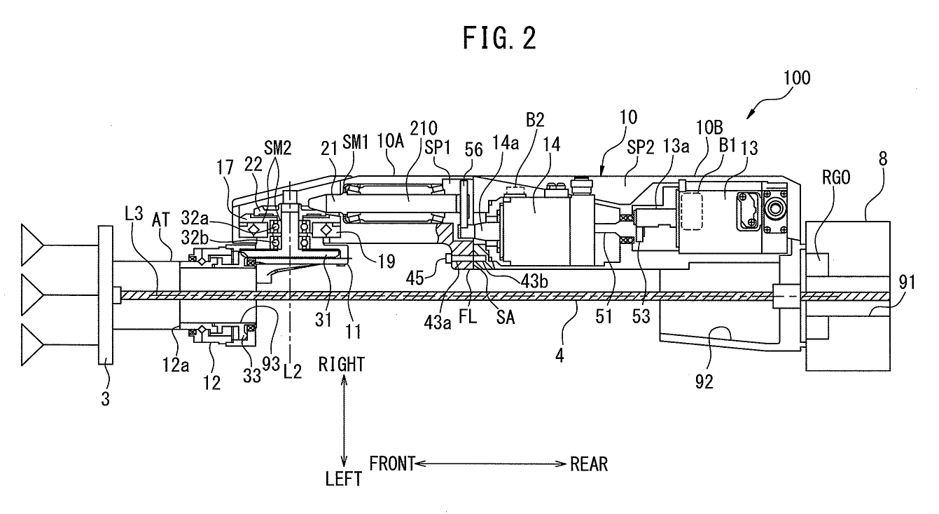

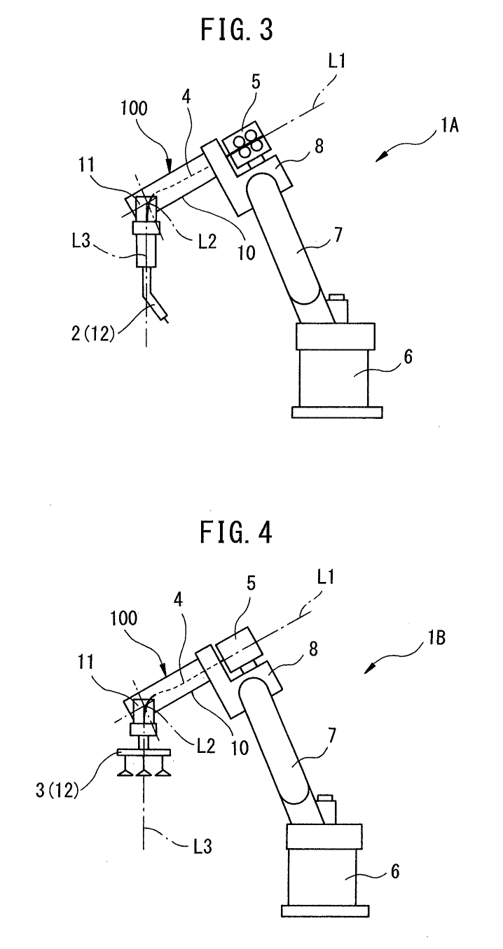

FIGS. 1 and 2 are respectively a front view and a side view illustrating the internal configuration of a wrist structure 100 of an industrial robot according to an embodiment of the present invention. FIGS. 3 and 4 are side views illustrating an example of industrial robots 1A and 1B to which the wrist structure 100 is applied.

First, the configuration of the industrial robots 1A and 1B will be described. The industrial robots 1A and 1B shown in FIGS. 3 and 4 are robots having six degrees of freedom in orthogonal axes. Specifically, FIG. 3 shows an arc welding robot 1A provided with a welding torch 2 as the wrist element of the final shaft, and FIG. 4 shows a handling robot 1B provided with a hand tool 3 as the wrist element of the final shaft. As shown in FIG. 3, a umbilical member 4 comprised of a bundle of a signal cable, a power supply cable, a welding wire, a gas hose, and a wire conduit, is connected to the welding torch 2. As shown in FIG. 4, a umbilical member 4 comprised of a bundle of a signal cable, a power supply cable, an air supply tube, etc., is connected to the hand tool 3.

In FIGS. 3 and 4, a base 6 is rotatable about a vertically extending axis, and an upper arm 7 is rotatably supported by the base 6. A forearm 8 is rotatably supported by a distal end of the upper arm 7, and a wrist structure 100 is supported by the forearm 8. The base 6, the upper arm 7, and the forearm 8 are rotatable in three degrees of freedom about three rotational axes. Note that the robots 1A and 1B in FIGS. 3 and 4 are different in the configuration of a third wrist element 12 as an end-effector, in the construction of the umbilical member 4 connected to the third wrist element 12, and in the structure of a feeding device 5 for feeding the umbilical member 4, but have the rest of the components in common. In short, both robots have the same base 6, upper arm 7, and forearm 8. The aforementioned operation tool, e.g., the welding torch 2 or the hand tool 3 is attached to a tool attachment part of the third wrist element.

The wrist structure 100 is comprised of the forearm 8, a first wrist element 10, a second wrist element 11, and the third wrist element 12, and has three degrees of freedom about three rotational axes. The first wrist element 10 is supported by the distal end of the forearm 8 so as to be rotatable about a first axis L1 which longitudinally extends. The second wrist element 11 is supported by the distal end of the first wrist element 10 so as to be rotatable about a second axis L2 intersecting with the first axis L1. The third wrist element 12 is supported by the distal end of the second wrist element 11 so as to be rotatable about a third axis L3 intersecting with the second axis L2.

The first axis L1, the second axis L2, and the third axis L3 intersect at one point, and the wrist structure 100 is constructed as an in-line wrist. This causes, as shown in FIG. 2, the first axis L1 and the third axis L3 to be situated on the same axis line, and reduces, at the time of rotation of the first wrist element 10, the interference radii of other wrist elements 11, 12. Further, the wrist structure 100 having good rotational balance as well as good controllability can be realized. Individual driving elements, which constitute the industrial robots 1A, 1B, are adapted to be driven by servomotors corresponding to the individual driving elements so as to take predetermined positions and attitudes in accordance with instructions from a robot controller (not shown).

The configuration of the wrist structure 100 will be described. Note that, for the purpose of illustration, the up-down direction, the front-rear direction, and the right-left direction are defined as shown in FIGS. 1 and 2, and the configuration of each component will be described in accordance with this definition. As shown in FIGS. 1 and 2, the first wrist element 10 extends in the front-rear direction, and its rear end is rotatably supported by the distal end of the forearm 8. A servomotor (not shown) and a first reduction gear RG0, which are adapted to rotate and reduce, at a predetermined reduction ratio, the speed of the first wrist element 10, are provided in the forearm 8. The first reduction gear RG0 is contained in the forearm 8 so that its output unit coaxially rotates with the first axis L1, and thus, the first wrist element 10 is driven, via the first reduction gear RG0, to rotate about the first axis L1.

The first wrist element 10 has a front case 10A and a rear case 10B, which are integrally fastened via an attachment surface SA extending in a direction perpendicular to the first axis L1, and storage spaces SP1 and SP2 are respectively formed inside the cases 10A and 10B. A servomotor 13 for driving the second wrist element 11 and a servomotor 14 for driving the third wrist element 12 are disposed in the storage space SP2 on the rear side. The servomotor 14 is disposed in front of the servomotor 13.

Output shafts 13a and 14a of the servomotors 13 and 14 project forward in parallel with the first axis L1. The servomotor 13 is positioned higher than the servomotor 14, and accordingly, the output shaft 13a extends above the first axis L1, and the output shaft 14a extends below the first axis L1. In other words, the output shafts 13a and 14a of the servomotors 13 and 14 are situated at offset positions such that they are generally symmetric with respect to a plane containing the first axis L1 and the second axis L2, and the servomotors 13 and 14 are provided in parallel to each other on two sides of the plane containing the first axis L1 and the second axis L2 at positions offset relative to each other in forward-rearward direction and partly overlapping each other.

Disposing the servomotor 13 for the second wrist on the proximal end side (rear side) of the first wrist element 10 and the servomotor 14 for the third wrist on the distal end side (front side) of the first wrist element 10 enables the two motors 13 and 14 to be arranged in partly overlapping manner, so that the cross sectional area of the first wrist element 10 can be made small.

A hypoid gear set 15 for reducing the rotation speed of the servomotor 13 at a predetermined reduction ratio, and a hypoid gear set 20 for reducing the rotation speed of the servomotor 14 at a predetermined reduction ratio are provided in the storage space SP1 on the front side. The hypoid gear sets 15 and 20 respectively have pinion gears (driving small gear wheels) 16 and 21 to be driven by the servomotors 13 and 14, and ring gears (driven large gear wheels) 17 and 22 to respectively mesh with the pinion gears 16 and 21.

The pinion gear 16 is provided at the distal end of a shaft 160 extending in the front-rear direction above the first axis L1, and the pinion gear 21 is provided at the distal end of a shaft 210 extending below the first axis L1. The pinion gear 16 (the shaft 160) is supported by the front case 10A so as to be rotatable about an axis L16 parallel with the first axis L1 via bearings (tapered roller bearings) 18a and 18b provided at the front and rear ends, and a needle bearing 18c provided between the bearings 18a and 18b. Likewise, the pinion gear 21 (the shaft 210) is supported by the front case 10A so as to be rotatable about an axis L21 parallel with the first axis L1 via bearings (tapered roller bearings) 23a and 23b provided at the front and rear ends, and a needle bearing 23c provided between the bearings 23a and 23b.

Bearing nuts 18d and 23d respectively apply precompression to the bearings 18a and 18b and the bearings 23a and 23b in the axial direction, to cause the rotation accuracy of the pinion gears 16 and 21 to be in best condition, and then the pinion gears 16 and 21 are rotatably supported. Providing the needle bearings 18c and 23c respectively between the paired bearings 18a and 18b and the paired bearings 23a and 23b enables, even when an external force exceeding the precompression causes the support by the bearings 18a and 18b and 23a and 23b to be incomplete, the needle bearings 18c and 23c to satisfactorily support the pinion gears 16 and 21. Note that sleeves can be used in place of the needle bearings 18c and 23c.

The ring gear 17 to mesh with the pinion gear 16 and the ring gear 22 to mesh with the pinion gear 21 are provided at the front end of the front case 10A, so as to be rotatable about the second axis L2. The ring gear 17 has a diameter larger than that of the ring gear 22, and the ring gear 22 is disposed on the right side of the ring gear 17. The pinion gear 16 is formed with right-hand teeth, and the pinion gear 21 is formed with teeth curved in a (leftward) direction different from the pinion gear 16. As seen above, the two pinion gears 16 and 21 are formed with symmetrically-formed teeth, and accordingly, the pinion gears 16 and 21 can be disposed at symmetrically offset positions in the direction perpendicular to the second axis L2.

As shown in FIG. 2, the positional relationship between the pinion gears 16 and 21 and the ring gears 17 and 22 is adjusted by a SIMM. In other words, a SIMM SM1 disposed in front of the bearings 18a and 23a adjusts the position of the pinion gears 16 and 21 in the front-rear direction, a SIMM SM2 disposed on the right side of a bearing 19 and a bearing 32a adjusts the position of the ring gears 17 and 22 in the right-left direction. This enables adjustment of backlash and tooth contact between the pinion gears 16 and 21 and the ring gears 17 and 22.

The ring gear 17 is integrally coupled to the second wrist element 11. The ring gear 17 is rotatably supported in the first wrist element 10 via the bearing 19, and the rotation of the ring gear 17 causes the second wrist element 11 to rotate about the second axis L2.

A bevel gear 31, the rotation center of which is the second axis L2, is provided in the second wrist element 11. The shaft of the bevel gear 31 extends along the second axis L2 in the right-left direction, and the inner peripheral surface of the ring gear 22 is splined to the shaft. The shaft of the bevel gear 31 is rotatably supported in the ring gear 17 via the paired bearings 32a and 32b, and the bevel gear 31 rotates about the second axis L2 together with the ring gear 22.

A bevel gear 33, the rotation center of which is the third axis L3, is provided in the third wrist element 12. The bevel gear 33 meshes with the bevel gear 31, and the rotation of the ring gear 22 causes the bevel gear 33 to rotate via the bevel gear 31. This causes the third wrist element 12 to rotate about the third axis L3. The outer diameter of the bevel gear 31 is larger than that of the bevel gear 33, and accordingly, when the power is transmitted from the bevel gear 31 to the bevel gear 33, the rotation speed of the bevel gear 33 increases.

An attachment surface 12a is formed at the front end of the third wrist element 12, and an attachment AT (the welding torch 2 of FIG. 3, the hand tool 3 of FIG. 4, etc.) adapted to the contents of work is detachably attached to the attachment surface 12a. The wrist structure 100 of this embodiment has three degrees of freedom about three rotational axes, and accordingly, can freely change the position and orientation of the attachment AT. In this instance, the distance between the second axis L2 and the center of the attachment AT is longer than the distance between the third axis L3 and the center of the attachment AT, and accordingly, driving torque larger than that necessary to drive the third wrist element 12 is needed to drive the second wrist element 11. In short, it is necessary to increase the reduction ratio of the servomotor 13 for the second wrist. When an attempt to obtain this reduction ratio from only the hypoid gear set 15 is made, the reduction ratio of the hypoid gear set 15 increases, and the power transmission efficiency reduces. Taking this point into consideration, in this embodiment, the wrist structure 100 is constructed as follows.

As shown in FIGS. 1 and 2, the wrist structure 100 has a power transmission unit 50 for the second wrist, which transmits the power of the servomotor 13 for the second wrist to the second wrist element 11, and a power transmission unit 55 for the third wrist, which transmits the power of the servomotor 14 for the third wrist to the third wrist element 12.

The power transmission unit 50 for the second wrist has the hypoid gear set 15, and a first deceleration unit RG1 and a second deceleration unit RG2, which are provided between the servomotor 13 and the hypoid gear set 15. A drive shaft 51 extends in the front-rear direction above the servomotor 14, and spur gears 52 and 53 are attached to the front and rear ends of the drive shaft 51. The drive shaft 51 is supported by the rear case 10B via a pair of bearings 51a and 51b, so as to be rotatable about an axis parallel with the first axis L1. Note that oil seals 51c and 51d are respectively provided behind the bearing 51a and in front of the bearing 51b, to prevent lubrication oil for the bearings 51a and 51b from entering toward the servomotor 14.

The spur gear 53 meshes with the output shaft 13a of the servomotor 13, and the rotation of the servomotor 13 is transmitted to the drive shaft 51 via the spur gear 53. The outer diameter of the spur gear 53 is larger than that of the output shaft 13a, and the output shaft 13 and the spur gear 53 constitute the first deceleration unit RG1. The rotation of the servomotor 13 is reduced by the first deceleration unit RG1 at a predetermined reduction ratio, and the drive shaft 51 rotates at a speed lower than that of the servomotor 13.

The front end of the drive shaft 51 projects into the front case 10A, and the spur gear 52 is disposed within the front case 10A. A spur gear 54, which is rotatable about the axis L16, is attached to the rear end of the shaft 160 of the pinion gear 16. The spur gear 52 meshes with the spur gear 54, and the rotation of the drive shaft 51 is transmitted to the pinion gear 16 via the spur gears 52 and 54. The outer diameter of the spur gear 54 is larger than that of the spur gear 52, and the spur gears 52 and 54 constitute the second deceleration unit RG2. The rotation of the drive shaft 51 is reduced by the second deceleration unit RG2 at a predetermined reduction ratio, and the pinion gear 16 rotates at a speed lower than that of the drive shaft 51.

As seen above, the rotation of the servomotor 13 for the second wrist is transmitted to the pinion gear 16 via the two deceleration units RG1 and RG2. This enables the second wrist element 11 to rotate at a predetermined driving torque without mush increase of the reduction ratio of the hypoid gear set 15. For example, the reduction ratio of the first deceleration unit RG1 and the reduction ratio of the second deceleration unit RG2 can be set at 1:1.5 to 4, and the reduction ratio of the hypoid gear set 15 can be set at 1:8 to 20. Regarding the distribution in the reduction ratio of the first deceleration unit RG1 and the second deceleration unit RG2, an optimal value should be selected taking the structure of a portion, to which each deceleration unit is mounted, into consideration. For example, 1:1.5 can be selected in the first deceleration unit RG1, and 1:4 can be selected in the second deceleration unit RG2. Consequently, the reduction ratio of the hypoid gear set 15 can be reduced to 20 or below. Thus, the reduction ratio of the hypoid gear set 15 can be prevented from being excessive, and the transmission efficiency can be prevented from reducing.

The power transmission unit 55 for the third wrist has the hypoid gear set 20, the paired bevel gears 31 and 33, and a third deceleration unit RG3 provided between the servomotor 14 and the hypoid gear set. A spur gear 56, which is rotatable about the axis L21, is attached to the rear end of the shaft 210 of the pinion gear 21. The spur gear 56 meshes with the output shaft 14a of the servomotor 14, and the rotation of the servomotor 14 is transmitted to the pinion gear 21 via the spur gear 56. The outer diameter of the spur gear 56 is larger than that of the output shaft 14a, and the output shaft 14a and the spur gear 56 constitute the third deceleration unit RG3. The rotation of the servomotor 14 is reduced by the third deceleration unit RG3 at a predetermined reduction ratio, and the pinion gear 21 rotates at a rotation speed lower than that of the servomotor 14.

The rotation of the servomotor 14 for the third wrist is transmitted to the pinion gear 21 via the deceleration unit RG3. The distance between the third axis L3 and the center axis of the attachment AT is small, and accordingly, large driving torque necessary for the second wrist element 11 is not needed for the third wrist element 12. This enables only one deceleration unit RG3 to rotate the third wrist element 12 at a predetermined driving torque without much increase of the reduction ratio of the hypoid gear set 20. For example, the reduction ratio of the third deceleration unit RG3 can be set to be 1:3 to 5, and the reduction ratio of the hypoid gear set 20 can be set to be 1:10 to 20. Consequently, the reduction ratio of the hypoid gear set 20 can be reduced to 20 or below. Thus, the reduction ratio of the hypoid gear set 20 can be prevented from being excessive, and the transmission efficiency can be prevented from reducing.

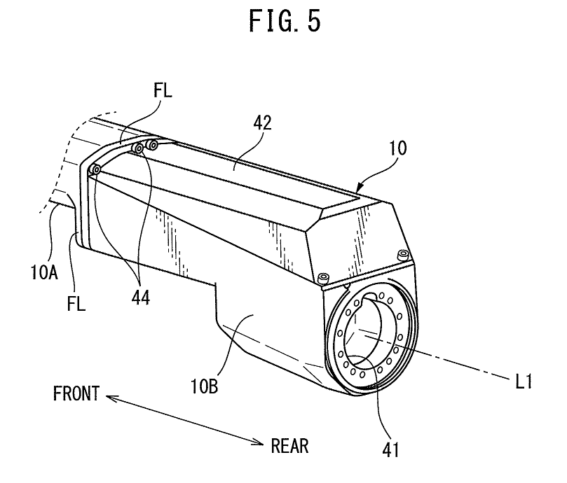

FIG. 5 is a perspective view, seen from obliquely behind, of the first wrist element 10. As shown in FIG. 5, a through-hole 41 is made, along the first axis L1, in the rear end of the first wrist element 10 (rear cover 10B), and a reduction gear mechanism (not shown) for reducing the rotation speed of the first wrist element 10 is disposed behind the through-hole 41. A hollow hole is formed in an output unit of the reduction gear mechanism, and a control cable to be connected to a connection between the servomotors 13 and 14 is inserted to the hollow hole. This absorbs torsion of the cable produced at the time of rotation of the first wrist element 10 about the first axis L1, and prevents damage such as breakage of the cable. A cover 42 is detachably attached to the first wrist element 10. The removal of the cover 42 enables the control cable to be easily attached to and detached from the connector between the servomotors 13 and 14.

As described above with reference to FIG. 2, the first reduction gear RG0 is contained in the forearm 8. A first hollow part 91 having a center axis coincident with the first axis L1 is formed in the first reduction gear RG0. Note that the first wrist element 10 is attached to the output unit of the first reduction gear RG0. Further, a through-passage 92 is formed in the first wrist element 10. Likewise, a second hollow part 93 having a center axis coincident with the third axis L3 is formed in the third wrist element 12.

As can be seen from, for example, FIG. 2, the umbilical member 4 fed from the feeding device 5 (tool management relay device) extends, through the first hollow part 91, the through-passage 92, and the second hollow part 93, to the hand tool 3 (or the welding torch 2). In short, in the present invention, the umbilical member 4 is positioned inside the wrist structure 100. This minimizes a gravitational load applied from the umbilical member 4 to two axes of the wrist.

In this respect, the welding torch 2 or the hand tool 3 having a light weight is attached to the third wrist element 12. Then the reduction ratio of the hypoid gear set 15 is reduced to, for example, 1:8 to 10. As necessary, the SIMM causes the pinion gear 16 to approach the second axis L2. The hypoid gear set 20 and the pinion gear 21 may be set in a similar manner.

As described above, when the reverse efficiency etc. of the hypoid gear set is adjusted, at least one of the servomotors 13 and 14 can support the weight load of the welding torch 2 or the hand tool 3 without having a built-in brake. Thus, in the present invention, regardless of the attitude of the robot, there is no possibility that members associated with axes for positioning the welding torch 2 or the hand tool 3, i.e., the first to third wrist elements may be accidentally detached.

In FIGS. 1 and 2, positions B1 and B2 are respectively designated by dashed lines in the servomotors 13 and 14. The positions B1 and B2 represent portions to which connectors for brakes for the servomotors 13 and 14 are attached. In the present invention, a brake is not needed for at least one of the servomotors 13 and 14, and accordingly, a connector for the brake can be omitted.

In the present invention, a brake and a connector for the brake of at least one of the servomotors can be eliminated, and accordingly, the entire weight of the wrist structure 100 can be reduced. This enables quick movement and precise positioning without accidental detachment of members associated with the axes.

Note that, when the welding torch 2 or the hand tool 3 has a relatively large weight, it is preferable that a brake for at least one of the servomotors 13 and 14 is attached. Thus, a connector for a brake may be attached to the positions B1 and B2. This enables a brake to be connected to a connector for the brake as necessary. Further, in order to accomplish this object, in the vicinity of the positions B1 and B2, it is preferable that a space, which is large enough to contain the brake, is prepared within the cover 42.

### Effect of the Invention

In the first aspect of the invention, gravitational loads based on the operation tool, which act on two axes of the wrist, can be minimized. Thus, when the operation tool has a relatively light weight, appropriately adjusting the reverse efficiency of the hypoid gears enables at least one motor to support the gravitational loads in the operation tool without containing a brake. Thus, members associated with axes, e.g., the first to third wrist elements can be prevented from being accidentally detached. As seen above, a brake of at least one motor can be eliminated, and accordingly, the entire weight of the wrist structure can be reduced. Thus, a wrist structure of an industrial robot, which can quickly move and can be precisely positioned without accidental detachment of members associated with axes, can be provided.

The above description is merely an example, and does not limit the present invention, by the aforementioned embodiments and modifications, as far as the features of the present invention are not impaired. Some of the components in the aforementioned embodiments and modifications can be obviously replaced as far as the identicalness of the invention is maintained. In other words, other embodiments derived from the technical idea of the present invention are included in the scope of the present invention. Further, a combination of the aforementioned embodiments and one or a plurality of modifications can be made.

What is claimed is:

1. A wrist structure of an industrial robot, comprising:
a forearm;
a first wrist element which is hinge-connected to a distal end of the forearm and which is rotatable about a first axis;
a second wrist element which is provided in the first wrist element so as to be rotatable about a second axis perpendicular to the first axis;
a third wrist element which is provided in the second wrist element so as to be rotatable about a third axis perpendicular to the second axis; and
an umbilical member which connects an operation tool attached to a tool attachment part of the third wrist element to a tool management relay device disposed behind the forearm, to supply at least one of power, a signal, and a material to the operation tool, wherein
the wrist structure of the industrial robot comprises:
a first reduction gear for rotationally driving the first wrist element;
a first deceleration unit and a second deceleration unit for rotationally driving the second wrist element;
a third deceleration unit for rotationally driving the third wrist element;
a motor for a second wrist and a motor for a third wrist, which respectively drive the second wrist element and the third wrist element; and
a transmission mechanism for the second wrist and a transmission mechanism for the third wrist, which respectively transmit a rotationally driving force of the motor for the second wrist and a rotationally driving force of the motor for the third wrist to the second wrist element and the third wrist element and which include hypoid gear sets,
a first hollow part having a center axis corresponding to the first axis is formed in the forearm,
a through passage, which communicates with the first hollow part, is formed in the first wrist element,
a second hollow part having a center axis corresponding to the third axis is formed in the third wrist element,
the umbilical member is inserted through the first hollow part, the through passage, and the second hollow part, and
a brake device is eliminated from at least one of the motor for the second wrist and the motor for the third wrist.
